(19) United States
(12) Patent Application Publication
(10) Pub. No.: US 2009/0055757 A1
(43) Pub. Date: Feb. 26, 2009

(54) SOLUTION FOR AUTOMATICALLY GENERATING SOFTWARE USER INTERFACE CODE FOR MULTIPLE RUN-TIME ENVIRONMENTS FROM A SINGLE DESCRIPTION DOCUMENT

(75) Inventor: CRAIG W. CHANEY, APEX, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/841,436

(22) Filed: Aug. 20, 2007

(51) Int. Cl. G06F 3/00

(52) U.S. Cl. 715/762

(57) ABSTRACT

The present invention discloses a system for using a single description document to automatically generate user interface (UI) code for multiple operating environments. Such a system can include a configuration description document, one or more target operating environment code generators, and a UI generation engine. The configuration description document can define UI elements using a standardized meta-language and a declaratively-specified configuration model. The target operating environment code generators can generate software code from the configuration description document that is specific to a target operating environment. The user interface generation engine can receive the configuration description document as input and automatically execute the target operating environment code generators.

### BACKGROUND

1. Field of the Invention

The present invention relates to the field of software code generation and, more particularly, to automatically generating software code for a user interface (UI) for multiple operating environments from a single description document.

2. Description of the Related Art

Software applications often require configuration information to be input by a user. This information is most often collected via a user interface (UI), such as a graphical user interface (GUI). Current business practices often require a software application to be written for use in a variety of operating environments, such as for the Web or for a command-line environment. These various operating environments typically utilize different interface conventions, requiring a software programmer to rewrite the UI code for each target run-time environment.

Few tools exist to assist a programmer in handling this need for modifying the code for a UI to function in various operating environments. For example, the C standard library contains a parsing function, getopt( ), for use in a command-line environment. However, use of the getopt( ) function requires that the programming language of the base software application support C library functions and that the command-line arguments received adhere to the syntax guidelines set forth by the Institute of Electrical and Electronics Engineers (IEEE).

The conventional approach of rewriting UI code to handle multiple operating environments is tedious and time-consuming. Further, this practice creates a situation where modifying the UI contents and/or implementing changes to an environment's interface conventions becomes a monumental undertaking. The extra time required to produce multiple interfaces can also impede an application's release and/or functionality.

What is needed is a solution that allows for a UI to be defined generically so that multiple user interfaces can be generated for various operating environments. That is, a UI can be described by a meta-language in a definition document and then processed by an engine that generates the UI code for selected target operating environments. Ideally, this solution would utilize a standardized meta-language with a declaratively-specified model, such as the user interface markup language (UIML), to describe the UI.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating a system for automatically generating user interface (UI) code for multiple target operating environments from a single configuration description document in accordance with embodiments of the inventive arrangements disclosed herein.

FIG. 2 is an example configuration description XML document describing a sample user interface (UI) in accordance with an embodiment of the inventive arrangements disclosed herein.

FIG. 3 is a collection of user interfaces (UIs) in accordance with an embodiment of the inventive arrangements disclosed herein.

### DETAILED DESCRIPTION OF THE INVENTION

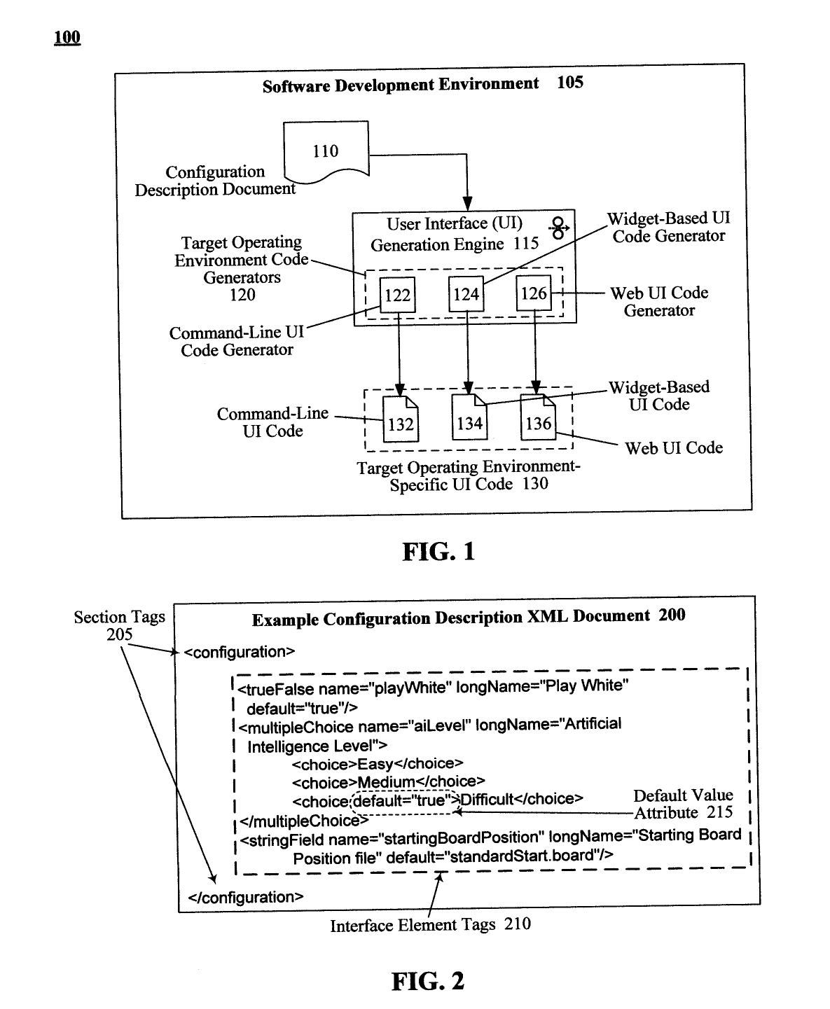

FIG. 1 is a schematic diagram illustrating a system 100 for automatically generating user interface (UI) code for multiple target operating environments 130 from a single configuration description document 110 in accordance with embodiments of the inventive arrangements disclosed herein. The components of system 100 can operate within a software development environment 105, which can utilize a variety of computing devices (not shown), software applications (not shown), and communication networks (not shown). Since the present invention is not limited to a specific configuration of the software development environment 105, only components that are particularly relevant to the present invention have been included in this figure.

In regard to the present invention, the software development environment 105 can include a configuration description document 110 and a user interface (UI) generation engine 115. The configuration description document 110 can describe a desired configuration of UI elements in a standardized meta-language, such as XML. The configuration description document 110 can also be written in accordance with a declaratively-specified configuration model, such as the user interface markup language (UIML).

It should be noted that use of both a standardized meta-language and declaratively-specified configuration model enables the UI generation engine to produce target operating environment-specific UI code 130. The generated UI code 130 can be optionally adjusted using standard software development tools. By using such a standardized high-level language to describe the UI, the UI generation engine 115 can create a one-to-many relationship between the configuration description document 110 and the UI code 130. Conventional approaches produce a one-to-one relationship between a description and the resultant code.

The UI generation engine 115 can be a software component of the software development environment 105 that translates the configuration description document 110 into target operating environment-specific UI code 130. As used herein, the term “target operating environment” describes the final operating environment that the generated UI code is meant to run in and is unrelated to the operating environment used in the software development environment 105. For example, the development environment 105 can be WINDOWS-based and the UI generation engine 115 can produce code for a command-line operating environment such as UNIX.

To perform these translations, the UI generation engine 115 can contain multiple target operating environment code generators 120. A target operating environment code generator 120 can be a software component of the UI generation engine 115 configured to convert the contents of the configuration description document 110 into the appropriate software code for its specific operating environment.

Each target operating environment code generator 120 can pertain to a different type and/or configuration of operating environment. For example, code generators 120 can exist for WINDOWS 98, WINDOWS XP, and WINDOWS VISTA as well as LINUX and SOLARIS. In another example, the target environment can also refer to a personal computer environment, a mobile computing environment, an embedded computing environment, and the like. In still another example, the target environment can refer to a Graphical User Interface (GUI) environment, a voice user interface (VUI) environment, a multimodal environment, and the like. The granularity at which the target operating environment is defined and implemented is arbitrary in that the disclosed solution can operate to create interfaces targeted at any definable environment.

The solution of environment 105 is extensible in that additional generators 120 can be added to the UI generation engine 115 to generate an interface from the configuration description document 110 for a new execution environment. In one embodiment, one or more of the generators 120 can be configured to developer preferences. For example, developer preferences can establish whether a GUI generator 120 is to create dockable toolbars or application ribbons from a related element specified in the configuration description document 110. In another example, user preferences can establish whether a VUI generator 120 is to generate VUI prompts for Dual Tone Multi-Frequency (DTMF) only input, voice only input, or either DTMF or voice input.

As shown in this example, the target operating environment code generators 120 consists of a command-line UI code generator 122, a widget-based UI code generator 124, and a Web UI code generator 126. As used herein, the term “widget” is used to generically describe the components of a UI, such as buttons, scroll bars, sliders, text boxes, and the like.

Each target operating environment code generator 120 can produce target operating environment-specific UI code 130. As shown in this example, the command-line UI code generator 122 produces command-line UI code 132, the widget-based UI code generator 124 produces widget-based UI code 134, and the Web UI code generator 126 produces Web UI code 136.

In an alternate embodiment, the UI generation engine 115 can include an interface (not shown) where a user can perform administrative tasks, such as adding or removing the target operating code generators 120 to be used by the generation engine 115.

FIG. 2 is an example configuration description XML document 200 describing a sample user interface (UI) in accordance with an embodiment of the inventive arrangements disclosed herein. Document 200 can be utilized in the context of system 100 for the generation of target operating environment-specific UI code.

It should be noted that the contents of document 200 are only to provide a simple example of a possible representation of a configuration description document written in XML; document 200 is not meant to be interpreted as an exact embodiment.

Consistent with XML documents, the description document 200 can contain a variety of tags 205 and 210 that can be recognized and translated by the UI generation engine. A section containing configuration data can be denoted by specialized beginning and ending tags 205.

UI elements can be defined in the section using interface element tags 210. In this example, the interface element tags 210 define a true/false element, a multiple choice element, and a text box element. The interface element tags 210 can include attributes that define the behavior of the specific interface element, such as a default value 215.

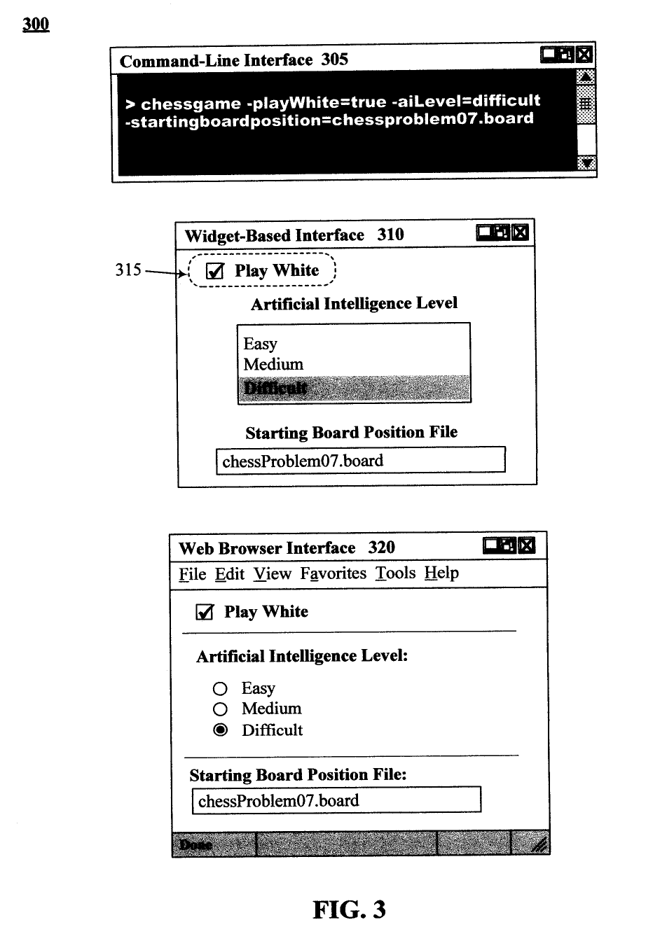

FIG. 3 is a collection 300 of user interfaces (UIs) 305, 310, and 320 in accordance with an embodiment of the inventive arrangements disclosed herein. The interfaces of collection 300 can be produced by system 100 and/or configuration description document 200. In this example, the interfaces of collection 300 represent interpretations of configuration description document 200.

Command-line interface 305 can represent the UI created when executing the UI code produced by a command-line code generator. The command-line code generator can translate the configuration description document into the proper software code for execution in a command-line operating environment.

As shown in the above example, the command-line interface 305 window displays a user-typed command that initiates a chessboard game.

Widget-based interface 310 can represent the UI created when executing the UI code produced by a widget-based code generator. The widget-based code generator can translate the configuration description document into the proper software code for execution in an operating environment that supports widgets, such as ECLIPSE.

The specific widgets used within the interface 310 to represent interface element tags of the description document can depend upon the translation algorithm of the widget-based code generator. In this example, the interface element tag “trueFalse” has been translated as a checkbox widget 315. Other widgets with similar functions, such as radio buttons and switches, could have been used as well. Selection of widgets for use by the code generator can be based upon a variety of factors, such as target operating environment capabilities, widget support, error handling of the host application, preferences established by a developer, and the like.

Web browser interface 320 can represent the UI created when executing the UI code produced by a Web code generator. The Web code generator can translate the configuration description document into the proper software code for execution in a Web browser, such as INTERNET EXPLORER or OPERA.

As with the widget-based interface 310, the specific Web page elements used in the Web browser interface 320 can depend upon the translation algorithm of the Web code generator. In this example, the interface element tag “multipleChoice” has been interpreted as a selectable list in the widget-based interface 310 and a group of radio buttons in the Web browser interface 320.

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A system for automatically generating user interface (UI) code for multiple operating environments from a single description document comprising:
a configuration description document that defines one or more elements of a user interface (UI), wherein the configuration description document is written using a standardized meta-language and a declaratively-specified configuration model;
a plurality of target operating environment code generators, each configured to generate a set of machine-readable instructions specific to a target operating environment based upon the configuration description document; and
a user interface generation engine configured to receive the configuration description document and automatically execute at least one of the target operating environment code generators, each of which results in a production of executable interface code.

2. The system of claim 1, wherein the configuration description document is written in an extensible markup language (XML) in accordance with a user interface markup language (UIML).

3. The system of claim 1, wherein the configuration description document contains processing logic, wherein the processing logic dictates a presentation of a specified UI element based upon a user-inputted value for at least one previously displayed element.

4. The system of claim 1, wherein the configuration description document contains a default value for the one or more UI elements.

5. The system of claim 1, wherein said components of claim 1 are utilized within a software development environment.

6. The system of claim 1, wherein the target operating environment is at least one of a Web-based environment, a widget-based environment, and a command-line environment.

7. The system of claim 1, further comprising:
an interface configured to allow configuration of the UI generation engine.

8. The system of claim 1, wherein the target operating environment code generators are extensible, wherein an addition of a new code generator results in an ability to generate interface code for a new target operating environment corresponding to the new code generator.

9. A method for automatically generating user interface (UI) code for multiple operating environments from a single description document comprising:
authoring a configuration description document, wherein the configuration description document is a meta-language document that defines elements of a user interface (UI) in accordance with a declaratively-specified configuration model;
determining at least one target operating environment for which interface code is to be generated;
conveying the configuration description document to a UI generation engine, wherein the UI generation engine contains a plurality of target operating environment code generators, said plurality of code generators including a code generator corresponding to each of the determined target operating environments of the determining step;
selecting a code generator for each of said at least one determined target operating environment; and
for each selected code generator, the UI generation engine automatically generating a set of software code files that corresponds to a corresponding one of the determined target operating environments, said set of software code comprising interface code for the target operating environment.

10. The method of claim 9, wherein the at least one determined target operating environment comprises a plurality of target operating environments, whereby a set of software code files is generated by the method for each of the target operating environments based upon the same configuration description document.

11. The method of claim 9, wherein the declaratively-specified configuration model is a user interface markup language (UIML).

12. The method of claim 9, wherein the meta-language is an extensible markup language (XML).

13. The method of claim 9, wherein the target operating environment is at least one of a Web-based environment, a widget-based environment, and a command-line environment.

14. The method of claim 9, wherein said steps of claim 9 are executed within a software development environment.

15. The method of claim 9, wherein the one or more target operating environment code generators used by the UI generation engine to generate the code files are selectable by a user.

16. The method of claim 9, wherein said steps of claim 9 are performed by at least one machine in accordance with at least one computer program stored in a computer readable media, said computer programming having a plurality of code sections that are executable by the at least one machine.

17. A user interface (UI) code generation engine comprising:
a plurality of operating environment code generators configured to generate a set of machine-readable instructions specific to a target operating environment based upon a configuration description document, wherein the configuration description document is written using a standardized meta-language and a declaratively-specified configuration model.

18. The UI engine of claim 17, wherein the configuration description document is written in an extensible markup language (XML) in accordance with a user interface markup language (UIML).

19. The UI engine of claim 17, wherein the target operating environment is at least one of a Web-based environment, a widget-based environment, and a command-line environment.

20. The UI engine of claim 17, wherein at least one of the code generators generates graphical user interface (GUI) code from the configuration description document, and wherein at least one of the code generators generates voice user interface (VUI) code form the configuration description document.
